(19) United States
(12) Patent Application Publication
(10) Pub. No.: US 2014/0046716 A1
(43) Pub. Date: Feb. 13, 2014

(54) AUTOMATED MANAGEMENT OF PHYSICAL RESOURCE SCHEDULING

(71) Applicants: Brandon Black, San Francisco, CA (US); Jonathan W. Chan, San Francisco, CA (US); Jonathan Chan, Sunnyvale, CA (US)

(72) Inventors: Brandon Black, San Francisco, CA (US); Jonathan W. Chan, San Francisco, CA (US); Jonathan Chan, Sunnyvale, CA (US)

(73) Assignee: Facebook Inc.

(21) Appl. No.: 13/584,481

(22) Filed: Aug. 13, 2012

Related U.S. Application Data
(60) Provisional application No. 61/682,175, filed on Aug. 10, 2012.

(51) Int. Cl. G06Q 10/10

(52) U.S. Cl. 705/7.19

(57) ABSTRACT

Managing a physical resource is disclosed. Layout information that can be used to identify a location of a physical resource within an environment is received. Calendaring information associated with a reservation of the physical resource is received. Sensor information associated with one or more sensors monitoring the physical resource is received. The layout information, the calendar information, and the sensor information are used to manage scheduling of the physical resource.

### CROSS REFERENCE TO OTHER APPLICATIONS

This application claims priority to U.S. Provisional Patent Application No. 61/682,175 entitled AUTOMATED MANAGEMENT OF PHYSICAL RESOURCE SCHEDULING filed Aug. 10, 2012 which is incorporated herein by reference for all purposes.

### BACKGROUND OF THE INVENTION

Electronic scheduling tools have simplified the process for reserving a physical resource such as a conference room. Using these scheduling tools, a user is able to view the availability of the resource in real time and electronically reserve the resource at a desired time. Advanced features such as reoccurring reservations allow a user to easily reserve the resource on an ongoing basis. However, the ease of the reservation process may lead to increased instances of unutilized reservations that could have been better utilized by another. Therefore, there exists a need for a better way to manage scheduling of a shared resource. Additionally, information collected during the reservation process can be integrated with additional information to further enhance user experience.

### BRIEF DESCRIPTION OF THE DRAWINGS

Various embodiments of the invention are disclosed in the following detailed description and the accompanying drawings.

FIG. 1 is a block diagram illustrating an embodiment of a resource management environment.

FIG. 2 is a flow chart illustrating an embodiment of a process for managing scheduling of a physical resource.

FIG. 3 is a flow chart illustrating an embodiment of a process for analyzing information associated with a reservation.

FIG. 4 is a flow chart illustrating an embodiment of a process for analyzing a reservation.

FIG. 5 is diagram illustrating an embodiment of a user management user interface.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Managing scheduling of a physical resource is disclosed. Examples of the physical resource include a building, a space, a room, an object, a location, a seating, and a tangible or location resource that can be located within a physical environment. The physical resource may be included in a group of managed physical resources. In some embodiments, the physical resource is a shared resource that can be reserved and shared amongst a group of users. Calendar information, layout information, and sensor information are used to manage scheduling of the physical resource. The layout information includes configuration of an environment where a physical resource may be located. For example, a floor plan that can be used to locate a conference room resource within a building is used. The calendaring information is associated with a utilization of the physical resource. For example, the calendaring information includes a schedule of reservations booked for the physical resource by one or more users. Directory information may be used to obtain information about the one or more users of the physical resource. The sensor information may be initially obtained from one or more sensors monitoring the physical resource. For example, information from a motion sensor that monitors the utilization of a conference room resource is used. An example of managing scheduling of the physical resource includes graphically displaying a location, reservation availability, and an indicator of current utilization of the physical resource. Another example of managing scheduling of the physical resource includes predictively determining a suggested modification of a reservation of the physical resource based on historical utilization and reservation information for a particular user.

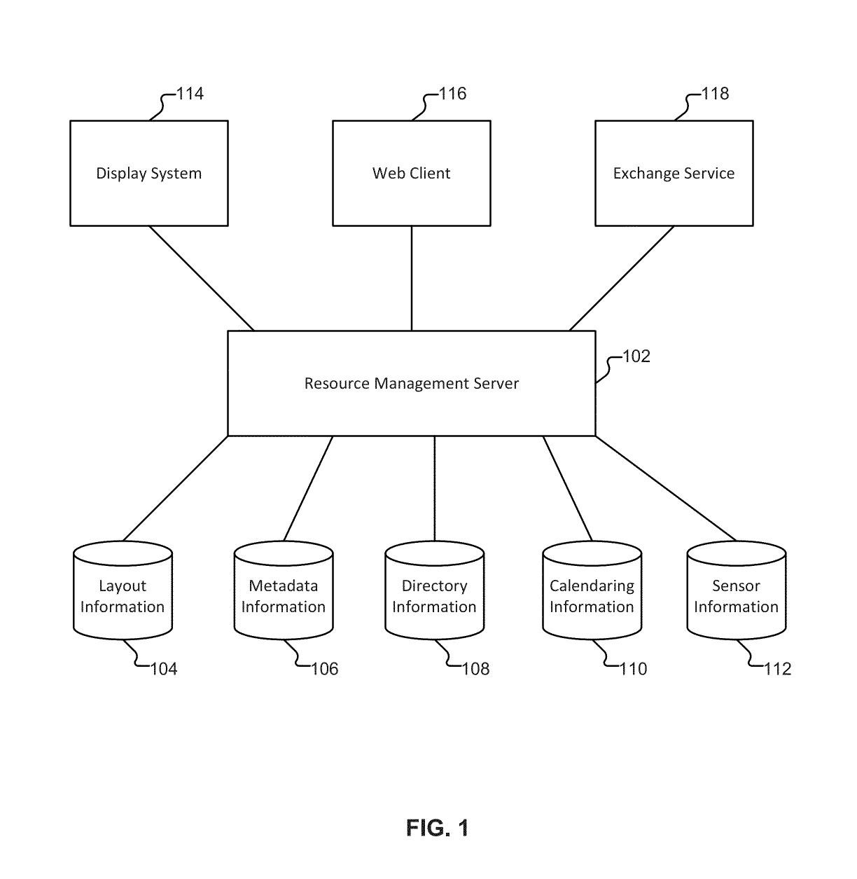

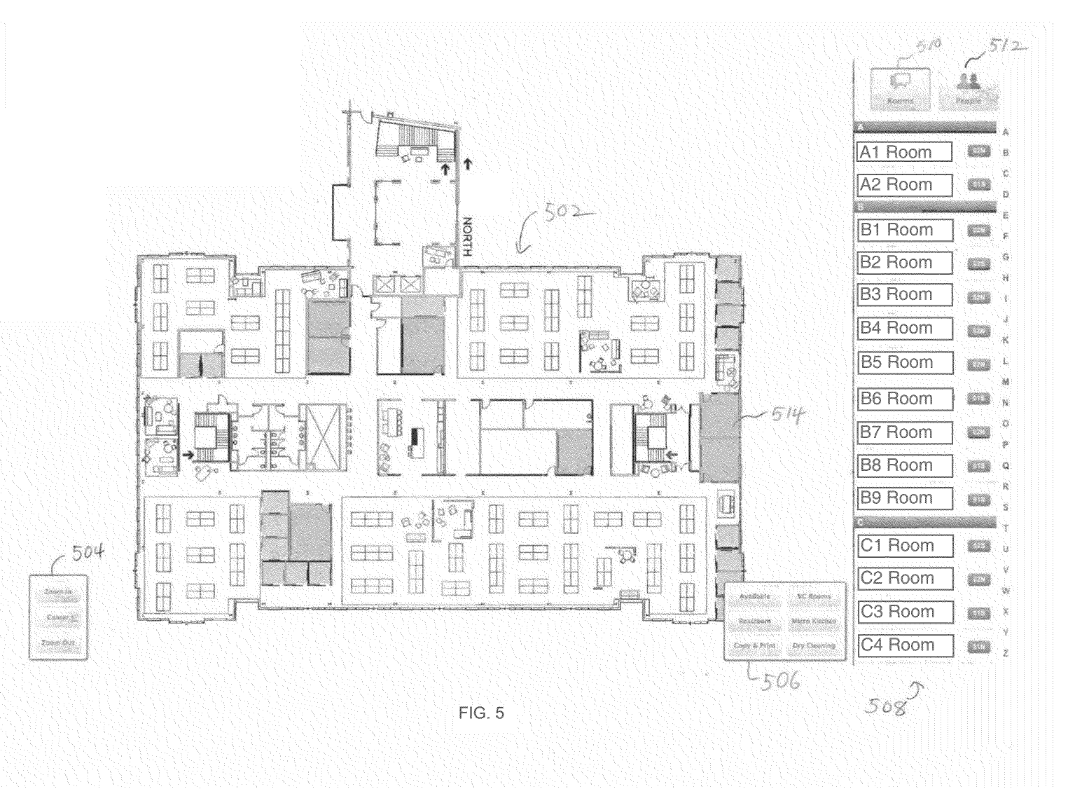

FIG. 1 is a block diagram illustrating an embodiment of a resource management environment. Resource management server 102 obtains layout information 104, metadata information 106, directory information 108, calendaring information 110, and sensor information 112. The information obtained by server 102 may be obtained from one or more other servers and/or devices such as a sensor device. The information may be pushed and/or pulled periodically and/or dynamically. Resource management server 102 processes the obtained information to manage one or more physical resources. In the example shown, display system 114 is connected to resource management server 102 and server 102 provides information to be displayed by display system 114. Display system 114 displays at least a portion of the obtained information of server 102. For example, display system 114 includes a touch screen display that displays a layout of a floor plan with overlaid conference room information that includes a name, a reservation schedule, and motion detection status of the conference room. A user may be able to interact with a touch screen interface of display system 114 to view and interact with information provided by resource management server 102. The example shown in FIG. 5 may be shown by display system 114.

Web client 116 is connected to resource management server 102 and web client 116 is able to access information gathered and processed by server 102 via a web interface. Using the web interface, a user of web client 116 may be able to locate a resource, view availability of the resource, and reserve the resource. Exchange server 118 is connected to resource management server 102. Exchange server 118 provides messaging and reservation services to resource management server 102. For example, server 102 is able to send an email notification to a user who has reserved a resource and/or modify an attribute of a reservation via exchange service 118. A reservation schedule of a resource may be managed by exchange service 118. In some embodiments, directory information 108 and/or calendaring information 110 may be provided by exchanger server 118 to resource management server 102. In some embodiments, exchange service 118 is included in a Microsoft Exchange Server provided by Microsoft Corporation of Redmond, Wash.

In various embodiments, the components shown in FIG. 1 may exist in various combinations of hardware machines. One or more of the components shown in FIG. 1 may be included in the same machine. For example, exchange service 118 and calendaring information 110 may be included in the same server. In the example shown in FIG. 1, portions of the communication path between the components are shown. Other communication paths may exist and the example of FIG. 1 has been simplified to illustrate the example clearly. The components of FIG. 1 may communicate with another component via a network. Examples of the network include one or more of the following: a direct or indirect physical communication connection, mobile communication network, Internet, intranet, Local Area Network, Wide Area Network, Storage Area Network, and any other form of connecting two or more systems, components, or storage devices together. Although single instances of components have been shown to simplify the diagram, additional instances of any of the components shown in FIG. 1 may exist. Components not shown in FIG. 1 may also exist.

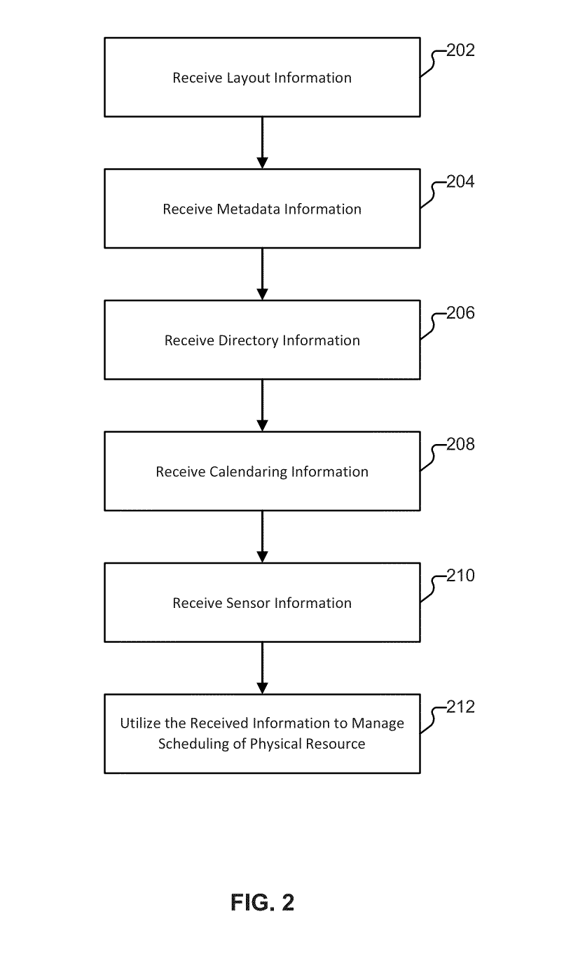

FIG. 2 is a flow chart illustrating an embodiment of a process for managing scheduling of a physical resource. The process of FIG. 2 may be implemented on resource management server 102. At 202, layout information is received. In some embodiments, the layout information includes layout information 104 of FIG. 1. In some embodiments, the layout information includes Computer-aided design (CAD) data. For example, the layout information includes a CAD file that specifies a floor plan of a building space where one or more physical resources may exist. Other examples of the layout information include a drawing, a map, a specification of a virtual environment, and other specifications of a space and/or object layout. In some embodiments, the received layout information is converted to a different format. For example, a CAD file is converted into one or more images that can be easily displayed without rendering the CAD file. In other embodiments, the CAD file may be rendered directly by an end user device.

At 204, metadata information is received. In some embodiments, the metadata information includes metadata information 106 of FIG. 1. In some embodiments, metadata information includes information about one or more components of layout information received in 202. For example, attributes about a location in a layout (e.g., identifier, name, capacity, space configuration, equipment located in a room, etc.) or other objects and space in the layout information are included in the metadata information. In some embodiments, an object/space in the layout information is associated with an identifier and the metadata information identifies information about the object/space using the identifier.

At 206, directory information is received. In some embodiments, the directory information includes directory information 108 of FIG. 1. In some embodiments, directory information includes information about one or more potential users of a resource. For example, directory information includes information about employees of an organization that are able to reserve one or more resources of the organization. Directory information may include a user identifier, a privilege level, a computing device identifier, a name, an email address, contact information, an alias, a start date, a manager identifier, a group identifier, an identifier of a reporting user, and a join date of a user. The directory information may be provided by a directory service such as Active Directory service of Microsoft Corporation.

At 208, calendaring information is received. In some embodiments, the calendaring information includes calendaring information 110 of FIG. 1. In some embodiments, calendaring information includes calendaring and scheduling information associated with one or more users and/or resources such as a physical resource. Calendaring information may include one or more reservations for one or more resources by one or more users. For example, the resource is a conference room and the calendaring information includes one or more reservations for the room that specifies the reservation time, reservation length, participants of the reservation, a subject for the reservation, notes for the reservation, a location of the reservation, availability information of one or more participants of the reservation, and contact information (e.g., associated with the received directory information) for one or more participants of the reservation. In some embodiments, the calendaring information is associated with a personal information manager that provides email, calendaring, and directory services for a user, such as services provided by exchange server 118 of FIG. 1.

At 210, sensor information is received. In some embodiments, the sensor information includes sensor information 112 of FIG. 1. In some embodiments, sensor information includes information detected using one or more of the following: a motion sensor, a pressure sensor, a temperature sensor, a camera, a microphone, a radio signal detector, a Wi-Fi receiver, a radio-frequency identification (RFID) detector, a Bluetooth detector, a light detector, a finger print reader, a biometric detector, and any other detector capable of detecting a property associated with a physical resource. In some embodiments, a plurality of sensors is associated with a single resource and the received information includes information from the plurality of sensors. In some embodiments, the sensor information includes information determined using data from one or more sensors. For example, using a plurality of sensors, utilization percentage of an enclosed space resource is determined and provided as sensor information.

The information received in steps 202-210 may be received periodically and/or dynamically. For example, information may be pushed/pulled at a predetermined interval. In another example, when new/updated information is detected, the information is dynamically received. Some information may be updated periodically while other information is updated dynamically. When certain information is updated it may cause other related information to be checked for an update and the other related information is requested/updated, if applicable.

At 212, the received information is utilized to manage scheduling of one or more physical resources. In some embodiments, utilizing the received information includes processing the received information. For example, the received information is stored, archived, converted, analyzed, updated, combined, merged, and/or otherwise processed to manage scheduling of one or more physical resources. In some embodiments, the received information is analyzed to discover and determine resources that will be managed. For example, obtained metadata information 106 and/or calendaring information 110 specifies one or more reservable physical resources that can be managed by resource management server 102. In some embodiments, associations are created between the received information. For example, each reservable physical resource is associated with a location identifier within a physical layout configuration using the layout information, description attributes using the metadata information, user information using the directory information, reservation information using the calendaring information, and sensor readings using the sensor information.

In some embodiments, the received information is visually combined on a display. For example, at least a portion of the received information is processed and presented in an overlaid graphical format. An example of the display is shown in FIG. 5. The displayed information may be updated periodically and/or dynamically as new information is updated. For example, a color associated with a resource is dynamically updated based on calendaring and sensor information. The resource is colored green if the resource is not reserved for the current time and a sensor has not detected current use of the resource, colored yellow if the resource has been reserved for the current time but a sensor has not detected current use of the resource, and colored red if the resource has been reserved for the current time and a sensor has detected current use of the resource. A user may be able to interact with the display via input such as a touch display. For example by selecting an object on the display representing the resource, a graphical representation of the location of the resource and an availability calendar of the resource is displayed. In some embodiments, the received information is processed, combined, and/or analyzed and made available via an interface. A user may use the interface to obtain desired information. For example, the information is made available via a display, a web interface, and/or an Application Programming Interface.

In some embodiments, utilizing the received information includes analyzing the received information to determine utilization information such as a utilization metric, utilization behavior or a utilization prediction. For example, utilization information such as historical, current, or predicted utilization information for a particular time, time period, user, group, user size, and/or utilization length is determined. This utilization information may be used to manage scheduling of a physical resource by storing the received/utilization information for future use, displaying the utilization information (e.g., display the likelihood a reservation will be utilized), modifying reservability of the resource (e.g., make a physical resource non-reservable for use by all, only reservable during historically busy utilization periods, only reservable by select user(s), etc.), and/or taking action based on a reservation (e.g., send notice, modify reservation, suggest different reservation, etc.).

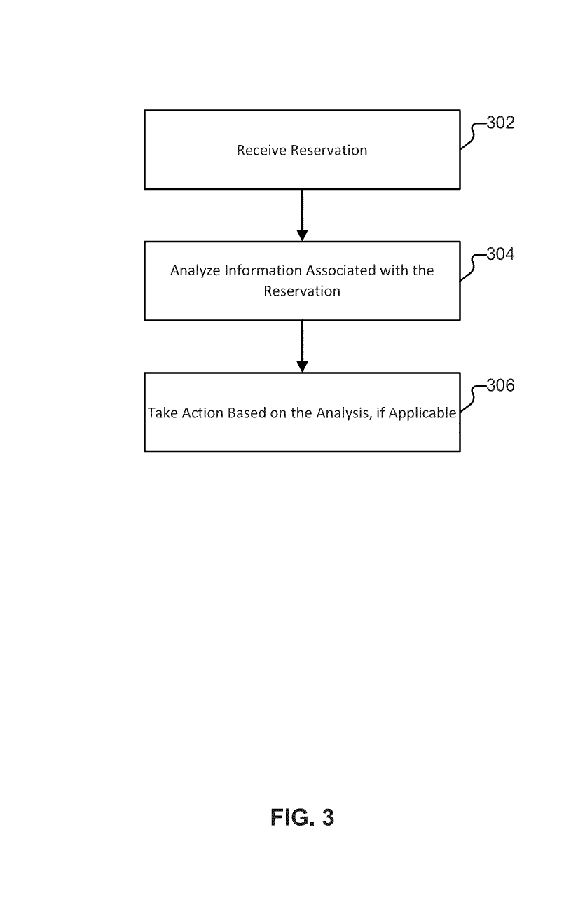

FIG. 3 is a flow chart illustrating an embodiment of a process for analyzing information associated with a reservation. In some embodiments, the process of FIG. 3 is included in 212 of FIG. 2. The process of FIG. 3 may be implemented on resource management server 102 of FIG. 1. At 302, a reservation is received. The reservation is associated with a reservation of a resource. For example, the reservation includes one or more identifiers associated with a resource (e.g., a conference room resource identifier), a start time of the reservation, a length of the reservation, an end time of the reservation, and/or one or more attendees of the reservation. In some embodiments, the reservation is associated with an appointment (e.g., Microsoft Outlook appointment) electronically scheduled with one or more attendees that will be using the resource.

In some embodiments, the reservation is included in calendaring information received at 208 of FIG. 2. In some embodiments, the reservation is included in one or more reservations received as an update to a previous update. For example, an update of new/modified reservations for one or more managed resources made after a previous update was received is requested/received periodically for processing. In some embodiments, an update of new/modified reservations for one or more managed resources made after a previous update was received is received dynamically as a reservation is created/modified. In some embodiments, the received reservation is associated with reservations that occur within a selected time period. For example, reservations that will occur within the next 24 hours are received. In some embodiments, the received reservation is associated with a reoccurring reservation. For example, a reoccurring reservation that is repeated on a specified periodic interval is received and analyzed after each instance of the reoccurring reservation passes in time.

At 304, information associated with the reservation is analyzed. In some embodiments, analyzing the information includes analyzing information, received in steps 202-210 of FIG. 2, that is associated with the reservation. In some embodiments, analyzing the information includes analyzing sensor information such as information received at 210 of FIG. 2. For example, sensor information is analyzed to determine whether a resource that is reserved for the current time is currently being utilized according to the sensor information. Sensors such as a motion sensor and a radio signal sensor (e.g., that detect presence of a device associated with a user) may be used to determine whether a resource and/or a reservation is being utilized. In some embodiments, analyzing the information includes analyzing calendaring information such as information received at 208 of FIG. 2 and/or previously received reservations. For example, historical sensor information and historical reservation information are analyzed to determine one or more properties (e.g., whether a reservation was actually utilized, reservation utilization time, etc.) of one or more previous reservations associated with the received reservation. In some embodiments, analyzing the information associated with the reservation includes determining utilization information such as a utilization metric, utilization behavior or a utilization prediction. For example, utilization information such as historical, current, or predicted utilization information for a particular time, time period, user, group, user size, and/or utilization length associated with the received reservation is determined. In some embodiments, a result of the analysis is stored for future use.

At 306, action based on the analysis is taken, if applicable. In some embodiments, the action includes associating information (e.g., results of the analysis) with the reservation. In some embodiments, the action includes sending a communication associated with the received reservation. For example, if it is determined from the analysis that the reservation will not likely be fully utilized (e.g., based on historical usage pattern of a user, the reservation is likely to end early, conference room is likely too large, etc.), an email notice is sent to a user who initiated the reservation to review the reservation and modify the reservation if not fully needed. A suggestion on how to modify the reservation may be offered and a user may accept the suggestion by indicating an acceptance of the suggestion. In some embodiments, the action includes automatically modifying the reservation. For example, if it is determined from the analysis that the reservation will not likely be fully utilized by analyzing historical usage patterns, the reservation is modified (e.g., length of reservation, reservation start time, reservation end time, cancel reservation, etc.). In another example, if the received reservation is not utilized within 30 minutes of the start of the reservation (e.g., detected using a motion sensor inside a conference room resource), the reservation is cancelled. A notice may also be sent to one or more users that the reservation has been modified. In some embodiments, if the analysis has detected that a different resource might be a better match for the reservation, the different resource may be indicated to a user of the reservation and/or the different resource may be automatically associated with the reservation instead of an initially selected resource of the reservation. For example, based on the latest updated number of participants of the reservation and/or required equipment of the reservation, a different conference room resource is suggested to a user of the reservation. In another example, if a resource becomes unavailable (e.g., due to repair of resource or higher priority reservation) after a reservation was made, the resource of the reservation may be automatically replaced with another automatically determined resource.

In some embodiments, the action includes associating a penalty or a reward to a user that made the reservation. For example, the analysis includes determining whether the reservation was utilized as indicated in the reservation. This may be verified using one or more sensors. If the reservation has been utilized in one or more matters indicated in the reservation (e.g., length of use, start time, end time, number of users, etc.), the user of the reservation may be rewarded and if the reservation has not been utilized in one or more matters indicated in the reservation, the user may be penalized. For example, the reward and penalty are associated with an indicator (e.g., value, percentage, level, etc.) that measures the user's reservation performance. The performance may be made publically available as a social reward/penalty. In another example, the rewards and penalty are associated with gaining or losing reservation privileges (e.g., ability to reserve a specific type of resource, duration, start time, priority, etc.). In some embodiments, the action includes controlling heating, cooling, and/or lighting associated with a resource. If the analysis indicated that no action is needed, no action is taken.

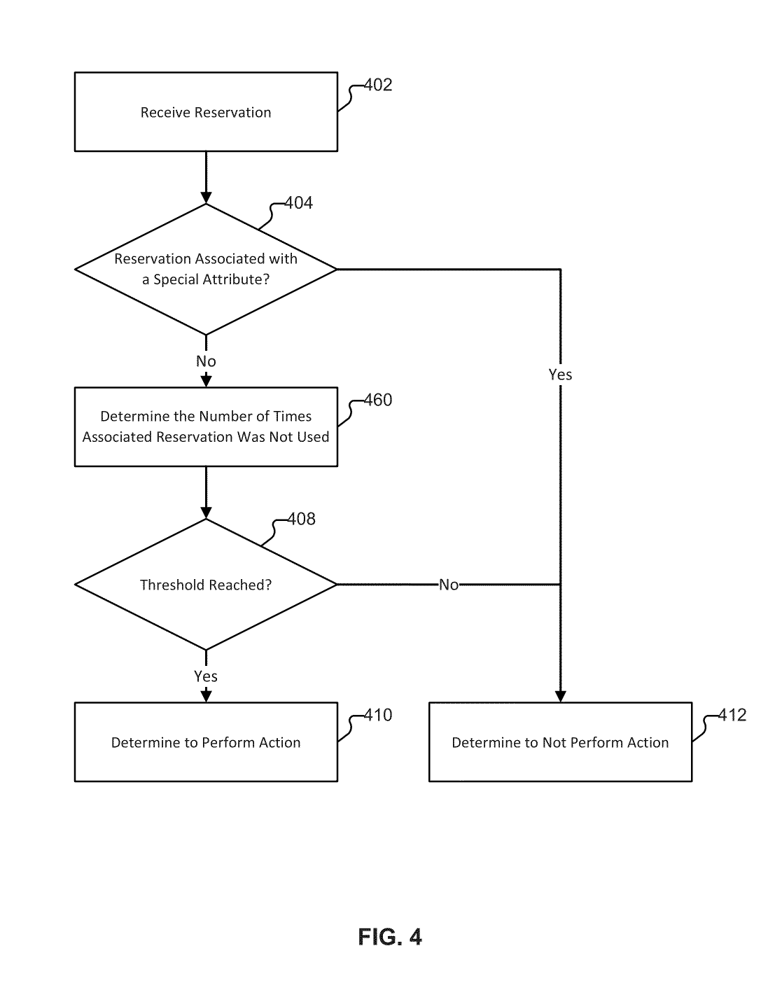

FIG. 4 is a flow chart illustrating an embodiment of a process for analyzing a reservation. In some embodiments, the process of FIG. 4 is included in 212 of FIG. 2. In some embodiments, the process of FIG. 4 is included in one or more steps of FIG. 3. The process of FIG. 4 may be implemented on resource management server 102 of FIG. 1. At 402, a reservation is received. In some embodiments, the reservation received in 402 is the reservation received at 302 of FIG. 3. In some embodiments, the received reservation is a reoccurring reservation. At 404, it is determined whether the received reservation is associated with a special attribute. In some embodiments, the special attribute may be associated with a type of reservation, a user that made the reservation, a user associated with the reservation, a time associated with the reservation and any other attribute of the reservation. For example, the reservation is associated with a special attribute because it was made by a user of high priority level. If at 404 the reservation is associated with the special attribute, at 412 it is determined that the action should not be performed. In some embodiments, not performing the action includes not performing the action in 306 of FIG. 3.

If at 404 the reservation is not associated with the special attribute, at 406 the number of times one or more associated reservation(s) were not used is determined. In some embodiments, determining the number of times includes determining the number of times a previous reservation of a reoccurring reservation has not been utilized. For example, a reservation may be determined to have been not utilized if a sensor didn't detect utilization of the reservation for at least 50% of the duration of the reservation. Other ways of determining whether an associated reservation was utilized may be used. The number of times in step 406 may be a percentage number. In some embodiments, determining the number of times includes determining the number of times a user that made the received reservation has not utilized one or more previous reservations of the user.

At 408, if it is determined that the number determined in 406 has not reached a threshold, the process proceeds to 412 where it is determined to not perform an action. At 408, if it is determined that the number determined in 406 has reached a threshold, the process proceeds to 410 where it is determined to perform an action. In some embodiments, performing the action includes performing the action in 306 of FIG. 3. For example, processing such as sending a notification or modifying the reservation as described in conjunction with step 306 of FIG. 3 is performed due to the determination made in 410.

FIG. 5 is diagram illustrating an embodiment of a user management user interface. The interface of FIG. 5 may be accessible via display system 114 of and/or web client 116 of FIG. 1. In some embodiments, the interface of FIG. 5 is generated at step 212 of FIG. 2. The interface shown in FIG. 5 includes floor plan 502, zoom control 504, finder control 506, and locator tab area 508. Floor plan 502 may be displayed using layout information 104 of FIG. 1 and/or layout information received at 202 of FIG. 2. For example, the floor plan 502 is rendered from CAD data received at 202 of FIG. 2. Overlaid on top of floor plan 502 are names associated with conference room resources shown in floor plan 502.

The names of the conference room resources are also shown in tab area 508. These conference room names may be obtained from metadata information 106 of FIG. 1 and/or step 204 of FIG. 2. By selecting a conference room resource name on tab area 508, the corresponding conference room is highlighted (e.g., indicators that are colored, shared, blinking, etc.) on floor plan 502. Items shown in tab area 508 may be toggled between showing conference room resource names (by selecting icon 510) and showing names of users (by selecting icon 512). The names of the users may be obtained from directory information 108 of FIG. 1 and/or directory information received at 206 of FIG. 2. By selecting a user name that may be shown in tab area 508, a location associated with the user is highlighted (e.g., indicators that are colored, shared, blinking, etc.) on floor plan 502. For example, a desk associated with the user may be indicated or if the user is currently scheduled to be attending a reservation of a conference room resource, the location of the conference is indicated.

The conference room resources (e.g., item 514) shown in floor plan 502 are colored/shaded to reflect a reservation and availability status associated with each of the conference room resources. The conference room resource is colored a first color/shade if the resource is not reserved for the current time and a sensor has not detected current use of the resource, a second color/shade if the resource has been reserved for the current time but a sensor has not detected current use of the resource, and a third color/resource if the resource has been reserved for the current time and a sensor has detected current use of the resource. The reservation information may be obtained from calendaring information 110 of FIG. 1 and/or received at step 208 of FIG. 2. The sensor information may be obtained from sensor information 112 of FIG. 1 and/or at step 210 of FIG. 2.

Icons in zoom control 504 may be appropriately selected to zoom in and out and center the display of floor plan 502. The icons of finder control 506 may be selected to identify one or more associated items on floor plan 502. The “available” button of finder control 506 may be selected to indicate on floor plan 502 the location of currently available conference room resources that are not currently reserved and not detected as being utilized according to sensor information. Some conference room resources shown in floor plan 502 are not reservable and only the sensor indicated availability is displayed.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for managing a physical resource, comprising:
a processor configured to:
receive layout information that can be used to identify a location of a physical resource within an environment;
receive calendaring information associated with a reservation of the physical resource;
receive sensor information associated with a sensor monitoring the physical resource; and
use the layout information, the calendar information, and the sensor information to manage scheduling of the physical resource; and
a memory coupled to the processor and configured to provide the processor with instructions.

2. The system of claim 1, wherein the physical resource includes an enclosed space within the environment.

3. The system of claim 1, wherein the physical resource is included in a group of managed physical resources.

4. The system of claim 1, wherein the layout information includes a floor plan.

5. The system of claim 1, wherein the processor is further configured to receive metadata information about one or more components of the layout information and the metadata information is used to manage scheduling of the physical resource.

6. The system of claim 1, wherein the processor is further configured to receive directory information about one or more users that may use the physical resource and the directory information is used to manage scheduling of the physical resource.

7. The system of claim 1, wherein the calendaring information can be used to determine an availability schedule of the physical resource.

8. The system of claim 1, wherein the reservation is associated with a personal information manager that provides a personal appointment scheduling functionality to a user that made the reservation.

9. The system of claim 1, wherein the sensor information is associated with a plurality of sensors monitoring the physical resource.

10. The system of claim 1, wherein managing scheduling of the physical resource includes associating together at least a portion of the calendaring information with at least a portion of the layout information and at least a portion of the sensor information.

11. The system of claim 1, wherein managing scheduling of the physical resource includes providing information that is used to visually display together at least a portion of the layout information with at least a portion of the calendaring information and at least a portion of the sensor information.

12. The system of claim 1, wherein managing scheduling of the physical resource includes analyzing at least the calendar information and the sensor information to determine a utilization metric.

13. The system of claim 1, wherein managing scheduling of the physical resource includes analyzing historical usage information to determine whether the physical resource will be likely utilized as specified by the reservation.

14. The system of claim 13, wherein the historical usage information is determined using the calendaring information and the sensor information.

15. The system of claim 13, wherein if it is determined that the physical resource will not be likely utilized as specified in the reservation, the processor is configured to send a message to a user of the reservation.

16. The system of claim 13, wherein if it is determined that the physical resource will not be likely utilized as specified in the reservation, the processor is configured to modify the reservation.

17. The system of claim 1, wherein managing scheduling of the physical resource includes analyzing at least the calendar information and the sensor information to determine a number of times one or more other reservations associated with the reservation was not fully utilized and if the number reaches a threshold value, the processor is configured to provide an indication that the threshold value has been reached.

18. The system of claim 17, wherein the reservation is a reoccurring reservation and the one or more other reservations is associated with one or more previous occurrence of the reservation.

19. A process for managing a physical resource, comprising:
receiving layout information that can be used to identify a location of a physical resource within an environment;
receiving calendaring information associated with a reservation of the physical resource;
receiving sensor information associated with a sensor monitoring the physical resource; and
using a processor to use the layout information, the calendar information, and the sensor information to manage scheduling of the physical resource.

20. A computer program product for managing a physical resource, the computer program product being embodied in a tangible computer readable storage medium and comprising computer instructions for:
receiving layout information that can be used to identify a location of a physical resource within an environment;
receiving calendaring information associated with a reservation of the physical resource;
receiving sensor information associated with a sensor monitoring the physical resource; and
using the layout information, the calendar information, and the sensor information to manage scheduling of the physical resource.
